(19) United States
(12) Patent Application Publication
(10) Pub. No.: US 2023/0041151 A1
(43) Pub. Date: Feb. 9, 2023

(54) COMPOSITE STRUCTURE FOR HIGH STRENGTH DOOR MODULE AND METHOD

(71) Applicant: MAGNA CLOSURES INC., Newmarket (CA)

(72) Inventor: Raymond Edward FORTIN, Newmarket (CA)

(21) Appl. No.: 17/881,489

(22) Filed: Aug. 4, 2022

Related U.S. Application Data
(60) Provisional application No. 63/230,164, filed on Aug. 6, 2021.

(51) Int. Cl. B60J 5/04

(52) U.S. Cl. CPC B60J 5/0416; B60J 5/0413; B60J 5/0418

(57) ABSTRACT

A carrier of a carrier module for a motor vehicle door assembly and method of manufacture thereof is provided. The carrier includes a body with opposite wet and dry sides bounded by an outer periphery configured for attachment to the inner panel to substantially close off the opening. The body is formed from a first material having a first density, with a plurality of voids provided in the body. Each of the plurality of voids has a second density, wherein the second density is less than the first density of the first material.

### CROSS-REFERENCE TO RELATED APPLICATION

This application claims the benefit of U.S. Provisional Application Ser. No. 63/230,164, filed Aug. 6, 2021, which is incorporated herein by reference in its entirety.

### FIELD

The present disclosure relates generally to vehicle door assemblies, and more particularly to carrier modules therefor.

### BACKGROUND

This section provides background information related to the present disclosure which is not necessarily prior art.

The automotive industry continuously seeks to utilize materials that are lightweight, readily recyclable and environmentally sustainable in components, where possible. In some cases, such as when a component may be exposed to high forces and/or exposed to moisture, the component may be made of a relatively heavy metal and/or reinforced plastic materials. One such component that is known to be made of metal or reinforced plastic is a carrier of a carrier module. As shown in FIG. 1, a carrier 1 has a body 2 molded from generally lightweight plastic material 3, such as polypropylene (PP). Being lightweight is desirable, however, the PP material 3 is relatively weak from a structural support and impact resistance standpoint, and thus, to enhance its strength, elongate reinforcement glass fibers 4 are typically molded therein. Although the glass fibers 4 can enhance the strength of the body 2 where present, they generally limit the shapes attainable in molding due to the elongate fibers 4 inability to flow throughout a mold cavity and inability to conform to the mold cavity. In fact, the glass fibers 4 are generally unable to be routed about sharp bends and corners 5 and throughout relatively narrow/thin regions 6. As such, the wall thickness of the carrier generally needs to be increased and the bends need to be provided having rounded, increased radius corners to allow the glass fibers to flow within the material and throughout the mold cavity. If the walls having relative thin regions 6, the glass fibers 4 will not flow through the thinned regions, and are known to accumulate and form a blockage 7, and thus, the wall will be devoid of glass fibers and weakened in the thinned regions 6, and in some cases, result in holes/openings being formed in the wall due to blocking the flow of the plastic material 3 in the thinned regions 6 of the mold cavity. Further yet, although the PP material 3 is generally able to be recycled, it is typically molded as a virgin material, and thus, is not as environmentally friendly as materials capable of being reclaimed, recycled and molded thereafter.

In view of the above, there is a need to provide a carrier that has enhanced environmental contributions, is environmentally sustainable and biodegradable, while at the same time being able to perform desired structural and barrier functions, that is strong and durable, that is able to be formed having sharp bends and corners, that is able attain a compact form/size for shipping and storage, that enhances economies of manufacture and assembly, while reducing weight to enhance fuel economy of the vehicle.

### SUMMARY

This section provides a general summary of the disclosure and is not intended to be considered a complete and comprehensive listing of the disclosure's full scope or all of its aspects, advantages, objectives and/or features.

It is an object of the present disclosure to provide a carrier for a carrier module of a door assembly of a motor vehicle that addresses at least those issues discussed above of known carriers.

In accordance with one aspect, the present disclosure is directed to a carrier for a carrier module of a door assembly of a motor vehicle that is made including recycled nylon.

In accordance with another aspect, the present disclosure is directed to a carrier for a carrier module of a door assembly of a motor vehicle that is environmentally sustainable, environmentally friendly, readily recyclable, has high structural strength to provide desired side impact resistance, is resistant to moisture and fluid penetration, thereby providing desired barrier function to prevent the transfer of moisture/fluid from a wet side of the carrier module to a dry side of the carrier module, is resistant to degradation in the presence of moisture/fluid, and reduces weight of the carrier module relative to those made of metal, thereby enhancing fuel economy of the vehicle.

In accordance with another aspect, the present disclosure is directed to a door assembly for a motor vehicle having an outer panel, an inner panel, and a carrier module having a carrier that is environmentally friendly, made at least in part of recycled and readily recyclable materials, has high structural strength to provide desired side impact resistance, is resistant to moisture and fluid penetration, thereby providing a desired barrier function to prevent the transfer of moisture/fluid from a wet side of the carrier module to a dry side of the carrier module, is resistant to degradation in the presence of moisture/fluid, and reduces weight of the carrier module relative to those made of metal, thereby enhancing fuel economy of the vehicle.

In accordance with another aspect of the disclosure, a carrier for a carrier module of a motor vehicle door assembly having an inner panel and an outer panel defining a door panel structure with the inner panel having an opening to an internal door cavity between the inner and outer panels is provided. The carrier includes a body with opposite wet and dry sides bounded by an outer periphery configured for attachment to the inner panel to substantially close off the opening. The body is formed from a first material having a first density, with a plurality of voids provided in the body. Each of the plurality of voids has a second density, wherein the second density is less than the first density of the first material, thereby reducing the weight of the carrier.

In accordance with another aspect of the disclosure, the body is a polymeric material.

In accordance with another aspect of the disclosure, the polymeric material is Nylon.

In accordance with another aspect of the disclosure, the voids can be provided as gas bubbles.

In accordance with another aspect of the disclosure, the gas bubbles can be encapsulated by a wall, with the wall being made of a material different from the material of the body.

In accordance with another aspect of the disclosure, the wall can be made of glass.

In accordance with another aspect of the disclosure, the glass can be made of soda-lime borosilicate.

In accordance with another aspect of the disclosure, the walls can be provided as microspheres having a diameter between about 10 to 100 microns (μm).

In accordance with another aspect of the disclosure, the microspheres have a density between about 0.100 to 0.900 g/cc.

In accordance with another aspect of the disclosure, the microspheres have a strength ranging between about 1.00 to 200.00 MPa.

In accordance with another aspect of the disclosure, the body can be formed having a living hinge allowing portions of the body to be folded upon themselves, thereby facilitating ease of shipping and storage of the carrier.

In accordance with another aspect of the disclosure, the carrier can further include a fluid impervious layer covering at least the wet side to protect the carrier against absorbing water.

In accordance with another aspect of the disclosure, the fluid impervious layer can be provided to cover the wet side and the dry side of the body.

In accordance with another aspect of the disclosure, the fluid impervious layer can be provided to cover the entirety of the body.

In accordance with another aspect of the disclosure, at least one reinforcing member can be fixed to the body of the carrier, with the at least one reinforcing member not including the plurality of voids provided in the body, thereby maximizing the strength of the at least one reinforcing member.

In accordance with another aspect of the disclosure, the at least one reinforcing member can be formed from a polymeric material.

In accordance with another aspect of the disclosure, the at least one reinforcing member can be formed from the first material used to form the body, absent the voids.

In accordance with another aspect of the disclosure, the at least one reinforcing member can be welded to the body, such as via ultrasonic welding.

In accordance with another aspect of the disclosure, a method of constructing a carrier for a carrier module of a motor vehicle door assembly is provided. The method includes forming a body from a first material having a first density, with the body being formed having a wet side and an opposite dry side bounded by an outer periphery configured for attachment to an inner panel of the motor vehicle door assembly to substantially close off an opening in the inner panel. Further, incorporating a plurality of voids in the body, with each of the plurality of voids having a second density less than the first density of the first material.

In accordance with another aspect of the disclosure, the method can further include forming the body from Nylon.

In accordance with another aspect of the disclosure, the method can further include providing the voids as gas bubbles.

In accordance with another aspect of the disclosure, the method can further include providing the gas bubbles having a gas encapsulated by a wall, such that the gas occupies a volume defined by an inner surface of the wall, with the wall being made of a material different from the body of the carrier.

In accordance with another aspect of the disclosure, the method can further include providing the wall being made of glass.

In accordance with another aspect of the disclosure, the method can further include providing the walls as microspheres having a diameter between about 10 to 100 microns (μm).

In accordance with another aspect of the disclosure, the method can further include providing the microspheres having a density between about 0.100 to 0.900 g/cc.

In accordance with another aspect of the disclosure, the method can further include forming a living hinge in the body to allow portions of the body to be folded upon themselves.

In accordance with another aspect of the disclosure, the method can further include covering at least the wet side of the body with a fluid impervious layer.

In accordance with another aspect of the disclosure, the method can further include covering the wet side and the dry side of the body with the fluid impervious layer.

In accordance with another aspect of the disclosure, the method can further include covering the entirety of the body with the fluid impervious layer.

In accordance with another aspect of the disclosure, the method can further include fixing at least one reinforcing member to the body, with the at least one reinforcing member not including the plurality of voids.

In accordance with another aspect of the disclosure, the method can further include providing the at least one reinforcing member being formed from a polymeric material.

In accordance with another aspect of the disclosure, the method can further include providing the at least one reinforcing member being formed from the first material.

In accordance with another aspect of the disclosure, the method can further include welding the at least one reinforcing member to the body.

Further areas of applicability will become apparent from the description provided herein. The description and specific examples in this summary are only intended to illustrate certain non-limiting embodiments which are not intended to limit the scope of the present disclosure.

### BRIEF DESCRIPTION OF THE DRAWINGS

The drawings described herein are for illustrative purposes only of selected non-limiting embodiments and are not intended to limit the scope of the present disclosure. In this regard the drawings include:

FIG. 1 illustrates a carrier of a carrier module in accordance with the prior art;

FIG. 2 illustrates a vehicle having a closure panel constructed in accordance with an aspect of the disclosure;

FIG. 3 is a plan view of a wet-side of a carrier module of the closure panel of FIG. 2;

FIG. 4 is a plan view of a dry-side of the carrier module of FIG. 2;

FIG. 5 illustrates a schematic, fragmentary cross-sectional view of a carrier of the carrier module of FIG. 2;

FIG. 6 is an enlarged, schematic, fragmentary cross-sectional taken generally along the line 6-6 of FIG. 5;

FIG. 7A is a view similar to FIG. 6 of a carrier of the carrier module of FIG. 2 in accordance with another aspect of the disclosure;

FIG. 7B illustrates the carrier of FIG. 7A in a folded, stowed state;

FIG. 8A illustrates an exploded view of a carrier of the carrier module of FIG. 2 in accordance with another aspect of the disclosure;

FIG. 8B illustrates an assembled view of the carrier of FIG. 8A; and

FIG. 9 is a flow diagram illustrating a method of manufacturing a carrier in accordance with another aspect of the disclosure.

### DETAILED DESCRIPTION OF EXAMPLE EMBODIMENTS

In general, example embodiments of a door assembly with carrier module and carrier module therefor, of the type configured including window regulators to be installed within an internal door cavity of a motor vehicle door assembly and having a carrier configured to separate a wet side from a dry side of the door assembly, constructed/manufactured in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

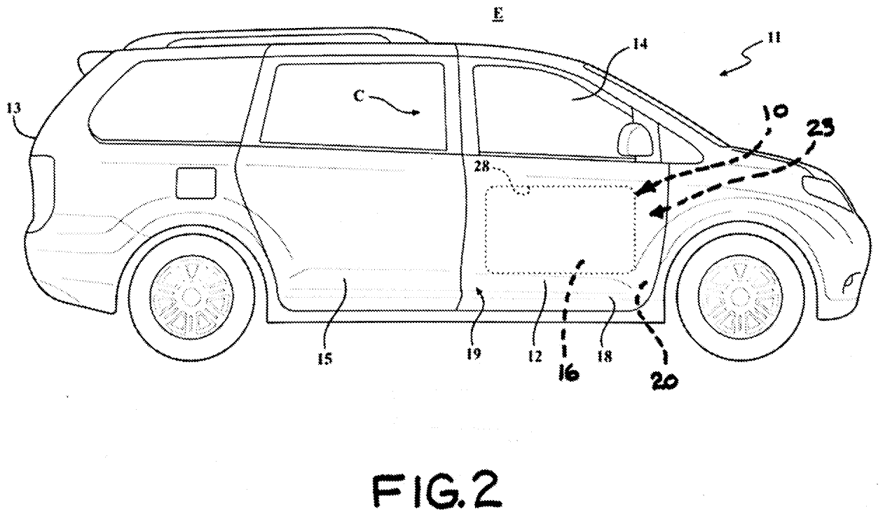

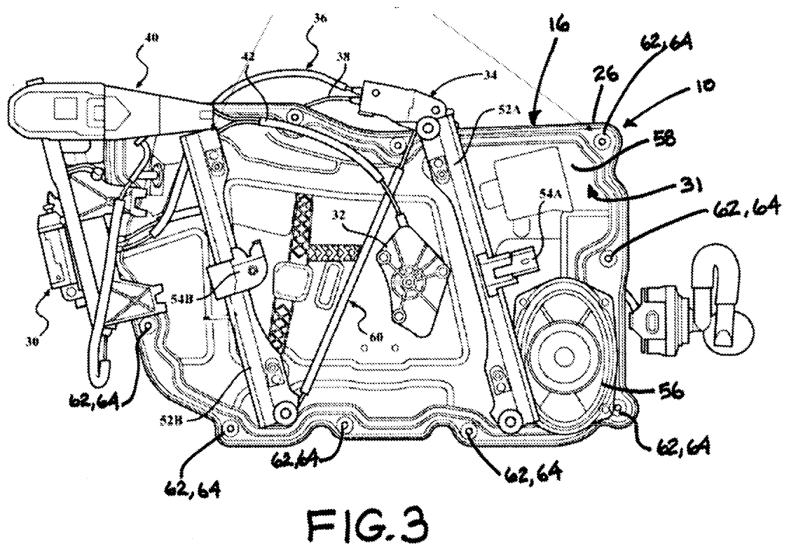

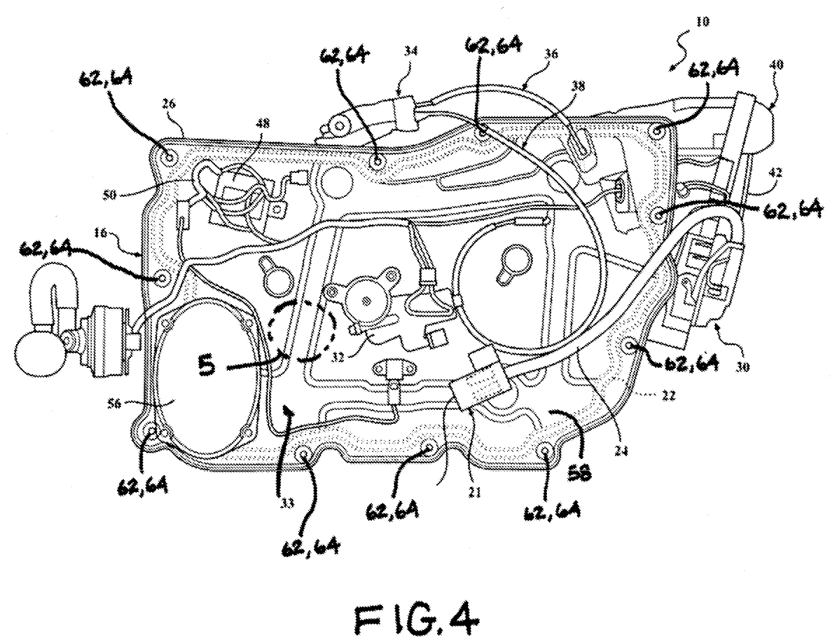

FIG. 2 shows a vehicle 11 having a plurality of motor vehicle closure assemblies, also referred to as door or closure panel assemblies, including front door closure panel assemblies 12, a rear hatch lift gate closure panel assembly 13, at least one sliding side door closure panel assembly 15, wherein one or more of the closure panel assemblies 12 can include a door module, also referred to as carrier module or carrier assembly 10 (FIGS. 3-4), constructed in accordance with an aspect of the disclosure. The carrier assembly 10 includes a carrier 16 and is further shown, by way of example and without limitation, as including an actuator 21 (FIG. 4) configured in operable communication with a latch assembly 30 via a rod or cable, such as a Bowden cable 24, to selectively cinch the latch assembly 30.

FIG. 3 shows a first side 31 (wet-side) of the carrier assembly 10 of one of the closure panel assemblies of FIG. 2, shown as one of the front door closure panel assemblies, referred to hereafter as door 12, by way of example and without limitation. It is to be recognized that the carrier assembly 10 can be configured having any surface contours and outer peripheral shape as desired for application with any of the closure panel assemblies of FIG. 2, as well as for other applications, including, but not limited to deck lids and the like. FIG. 4 shows a second side 33 (dry-side) of carrier assembly 10. The first side 31 of the carrier assembly 10 shown in FIG. 3 is referred to as the “wet-side” because, when the carrier assembly 10 is installed in a vehicle closure panel of vehicle 11, the first side 31 faces outwardly, away from the passenger compartment, also referred to as interior cabin C, and may be exposed to an ambient external environment E as a result of apertures in the panel assembly (such as the large slot through which a window 14 moves between open and closed positions). In contrast, the second side 33 of the carrier assembly 10 shown in FIG. 3 is referred to as the “dry-side” because, when carrier assembly 10 is installed in a vehicle closure panel of vehicle 11, the carrier 16 of carrier assembly 10 seals the interior cabin C of the motor vehicle 11 against the ambient external environment E such that the second side 33, which faces toward the interior cabin C, is protected from the external environment E and remains dry.

Carrier assembly 10 is shown to include the carrier 16, which is generally plate-like, being generally planar in configuration, with specifically and precisely located undulating contours, also referred to as surface profiles, provided as desired for the intended components and application, thereby providing the carrier 16 having a variety of integrally formed three-dimensional features within the material of the carrier 16. Carrier 16 holds a variety of functional door hardware components. Carrier 16 can be formed as a structural component in the sense that the door hardware components may be mounted thereto without requiring additional fasteners to mount the components to the structural panel assembly after installation of carrier assembly 10 therein. As is understood, front door 12 includes a structural door panel body, referred to hereafter as door panel structure or body 19, made up of a sheet metal inner door panel, also referred to as inner panel 20, joined to a sheet metal outer door panel, also referred to as outer panel 18, along their outer peripheral edge regions and/or elsewhere so as to define an internal door cavity 23 between the inner and outer door panels 20, 18. A window 14 is stored in internal door cavity 23 when moved to its opened position. Carrier 16 includes a circumferentially, continuously extending sealing bead 22 which is configured to extend adjacent an outer periphery 26 of carrier 16 and surround an opening 28 (FIG. 2) in inner door panel 20 in sealed relation thereabout when carrier 16 is assembled and mounted against inner door panel 20. Accordingly, the carrier 16 at least partially or entirely closes off the opening 28 of the inner door panel 20, as desired. Since carrier 16 is impervious to water, the sealing bead 22 acts to prevent infiltration of debris and other forms of contamination, including fluid and moisture, from the wet side 31 to the dry side 33 into the passenger interior cabin C.

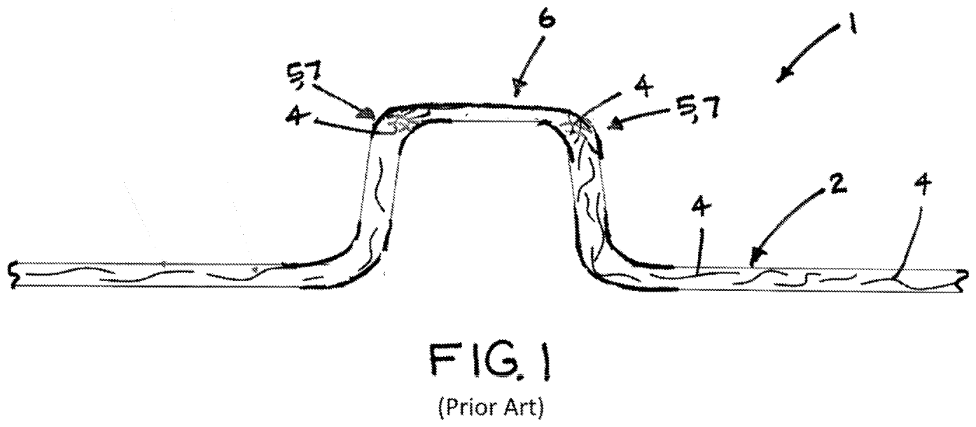

The carrier assembly 10 is shown carrying most, if not all, of the door hardware components for front door 12, by way of example and without limitation. Generally speaking, the functional hardware components secured to carrier 16 can, as shown, include the power-operated latch assembly 30, a power-operated window regulator 32, an inside handle unit 34 mechanically coupled to latch assembly 30 via an inside release mechanism 36 and via an inside lock/unlock mechanism 38, and an outside handle unit 40 mechanically coupled to latch assembly 30 via an outside release mechanism 42. The connector mechanisms can be Bowden cables and/or rod-links as is known. The functional hardware components are electrically coupled to an ECU 48 via a wiring harness 50. Carrier 16 further supports a pair of guide rails 52A, 52B which support corresponding lift brackets 54A, 54B for translational movement thereon. Lift brackets 54A, 54B support window 14 for movement along rails 52A, 52B between opened and closed positions. A cable and pulley-type window lift system 60 connects lift brackets 54A, 54B to a drum associated with power-operated window regulator 32. In addition to the door hardware components, carrier assembly 10 is further shown, by way of example and without limitation, as supporting a speaker 56 of a vehicle sound/entertainment system in a manner that optimizes the performance of the speaker 56, while resolving concern for privacy and sound transmission issues discussed above with regard to carrier 1 of FIG. 1.

Carrier 16 has a body 58 configured to be fixed to door panel body 19, such as to inner door panel 20, as discussed above, and can include a plurality of fastener through openings 62 adjacent the outer periphery 26 for receipt of fasteners (not shown) therethrough. If desired, metal or plastic grommets 64 can be fixed in each of the plurality of fastener through openings 62. Grommets 64 provide compressive structural support for receipt of the fasteners used to fix carrier 16 to inner door panel 20, wherein grommets 62 facilitate preventing over-compression and tearing of the body 58.

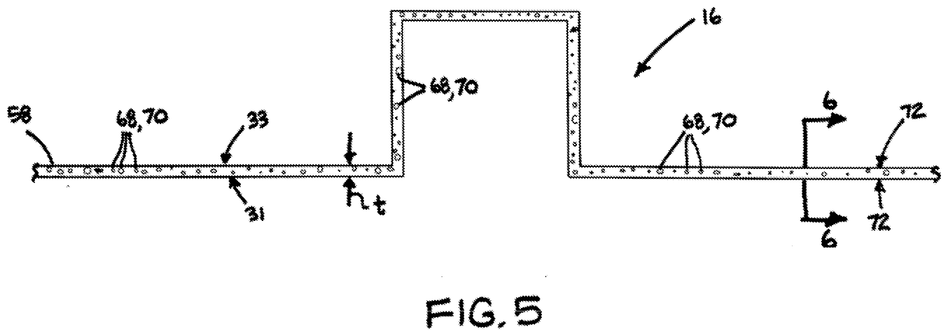

Carrier body 58 is formed, at least in part, and preferably entirely or substantially (substantially is intended to mean nearly entirely, also stated as from a significant majority, such as greater than 75% material content by weight) from a recycled and recyclable, material. With reference to FIG. 5, illustrating a fragmentary portion of body 58, with it to be understood that the remainder of body 58 can be formed having the same or substantially the same material content, the body 58 is formed from a first material 66 having a first density, with a second material 68, shown formed as a plurality of voids 68, provided in the body 58. The second material 68 forming the plurality of voids has a second density, wherein the second density is less than the first density of the first material 66, thereby reducing and minimizing the weight of the carrier 16. As such, with the second material 68 having a reduced density relative to the first material 66, the weight of the first material 66 can be increased to provide an increased strength relative to a material having a lower density, and thus, the carrier 16 is formed having a high strength, due to the first material 66, while being lightweight, due to the second material 68.

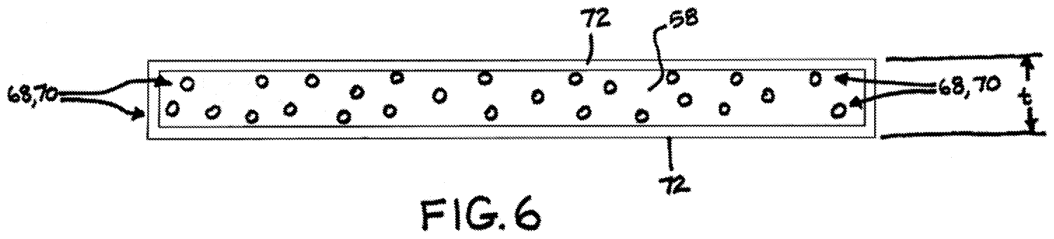

The body 58 is formed from a high strength polymeric material, i.e. thermoplastic polyamides, and in a preferred embodiment, of a nylon, without need of fibrous reinforcement. The nylon can be reclaimed, recycled material, which can be processed to be reformed to take on any desired shape of carrier 16. For example, the recycled nylon, such as post-consumer and/or post-manufacture (scrap) nylon, can be reprocessed into powder and/or pelletized form, wherein the reprocessed powder and/or pellets of nylon can be molded via any desired molding process, including compression or injection molding, by way of example and without limitation. Nylon is an exceptionally strong material, having a tensile strength of about 76 MPa and a flexural strength of about 110 MPa, and also comes with a high temperature resistance having a melt point of about 220° C. Although nylon generally has a density of about 1.13 to 1.35 g/cc, the incorporation of the second material 68 reduces the overall density of carrier 16 by about 10% or more, while not adversely impacting the strength of the first material 66. Further, given the relatively high strength of the first material 66, a wall thickness (t; FIGS. 5 and 6) of the body 58 can be minimized while still providing a desired, high level of impact protection to the carrier 16. Accordingly, the space occupied by, and the weight of the finished carrier 16 can be kept to a minimum.

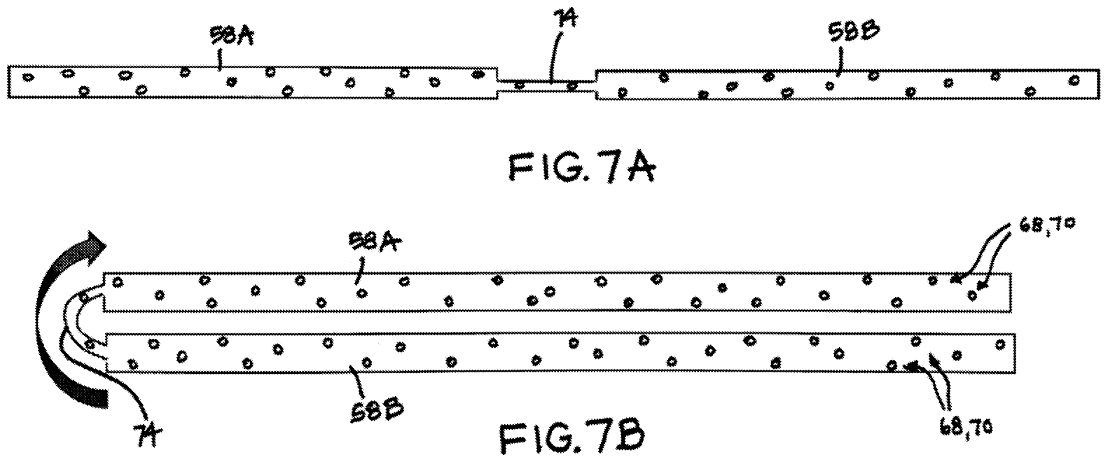

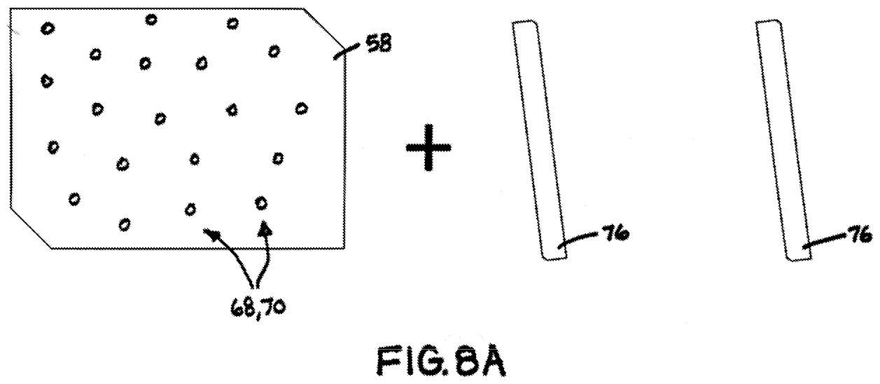

The second material voids 68 can be provided as self-contained, discrete gas bubbles, and in accordance with one aspect of the disclosure, each of the gas bubbles can be encapsulated by a wall 70, with the walls 70 being made of a material different from the body 58. The walls 70 can be made of glass, such as from a soda-lime borosilicate, by way of example and without limitation. The walls 70 can be provided as microspheres having a diameter between about 10 to 100 microns (μm) and having a density between about 0.100 to 0.900 g/cc. Accordingly, incorporating the microspheres 70 into the body 58 reduces the density of the body 58, such as to a density between about 1.20 to 1.25 g/cc, with the microsphere 70 content being about 30% by volume. The microspheres 70 have a strength ranging between about 1.00 to 200.00 MPa, and thus, incorporation of the microspheres 70 into the high strength body 58 can increase the overall strength of the body 58. The microspheres 70 can readily flow within the first material 66 as the first material 66 is being molded, thereby avoid problems associated with reinforcement fibers, which are eliminated from carrier 16. Accordingly, the microspheres 70 allow the carrier 16 to be formed having sharp corners and reduced thickness regions (FIGS. 5, 7A and 7B), without concern of forming weakened regions associated with the prior art (FIG. 1).

In accordance with another aspect of the disclosure, the carrier 16 can further include a fluid impervious sealant material, also referred to as fluid impervious layer or water barrier 72, covering at least the wet side 31 to protect the carrier 16 against absorbing moisture and water. Accordingly, the water barrier 72 can be fixed to as least the wet side 31 of body 58, and also to both the wet side 31 and the dry side 33, and further, about the outer periphery, if desired, to prevent moisture or fluid on the wet side of carrier 16 from reaching the first material 66 of the body 58. If desired, the water barrier 72 can be provided as a preformed solid sheet of sealant material, such as a polymeric material, that is subsequently fixed to at least the wet side 31 and optionally to the dry side 33, such as via an adhesive and/or mechanical fastener. Water barrier 72 can also be applied as a fluid via a spraying, dipping, or other coating process either prior performing the molding operation and/or after performing the molding operation, and thus, can readily be applied to the entirety of the water barrier 72.

In accordance with another aspect of the disclosure, as shown in FIGS. 7A and 7B, the body 59 can be formed having at least one living hinge 74, such as extending along an approximate geometric center, by way of example and without limitation, thereby allowing adjacent portions 58A, 58B of the body 58 to be folded upon themselves (FIG. 7B), thereby facilitating ease of shipping and storage of the carrier 16. Of course, it is to be recognized that the living hinge(s) 74 can be formed to extend along any regions of body 58 desired to provide the desired folding relation between adjacent regions of body 58.

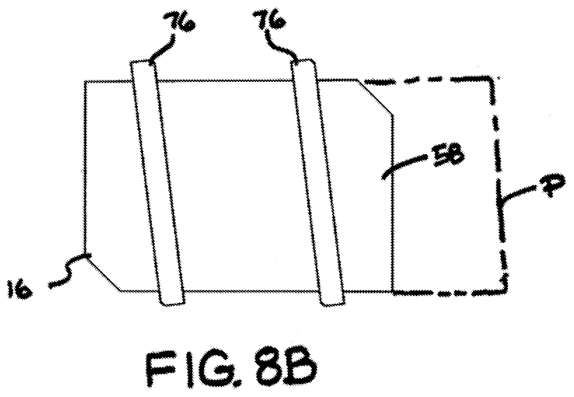

In accordance with another aspect of the disclosure, as shown in FIGS. 8A and 8B, at least one, and shown as a pair of reinforcing members 76, by way of example and without limitation, can be fixed to the body 58. The body 58 is as discussed above, including voids 68, with the reinforcing members 74 not including the voids 68 provided in the body 58. Accordingly, the reinforcing members 76 can attain the full strength of the material used to form the reinforcing members 76, thereby maximizing the strength of the reinforcing members 76. It is contemplated herein that the reinforcing members can be made of any desired polymeric material, including a recycled nylon material as used to construct body 58, or otherwise, could be formed of a metal, if desired. If constructed from a polymeric material, and in particular the same nylon as used to make body 58, the reinforcing member(s) 76 can be welded to the body 58, such as via ultrasonic welding.

The reinforcing members 76 have a resistance to loading, such as a resistance to bending or deformation for example as caused by a load applied to the carrier 16, and for example having a strength and/or stiffness greater than the material of the carrier 16. The reinforcing members 76 provide the carrier 16 with an enhanced impact resistance against impact forces directed transversely to a plane P (FIG. 8A) along which carrier 16 generally extends, thereby enhancing the side impact resistance of carrier 16 and door 12, thus, providing enhanced protection to occupants within motor vehicle 11 during side impacts, such as those experienced during an accident. Also, the reinforcing members 76 may be provided as, or in addition to, a high-stiffness member augmenting the stiffness of the carrier module 16 to withstand deformation, for example caused by road vibration, or sound vibrations generated by speakers mounted to the carrier 16. The enhanced side impact resistance provided by carrier 16 eliminates the need for separate side impact beams/members, including those commonly found extending within a cavity of a door assembly, thereby freeing up space within cavity 23, which ultimately makes assembly of components therein easier. Further yet, as will be appreciated by the skilled artisan, economies of manufacture and assembly are recognized by having the reinforcing members 76 integrated as a component of the carrier 16. The enhanced stiffness of the carrier 16 provided by reinforcing members 76 may eliminate the development of resonance frequencies within the carrier 16 and may improve the sound performance of mounted speakers to the carrier module 16. However, it is to be recognized that carrier 16 can be manufactured as a stand-alone carrier 16, without reinforcing members 76 integrated therein, if desired for the intended application.

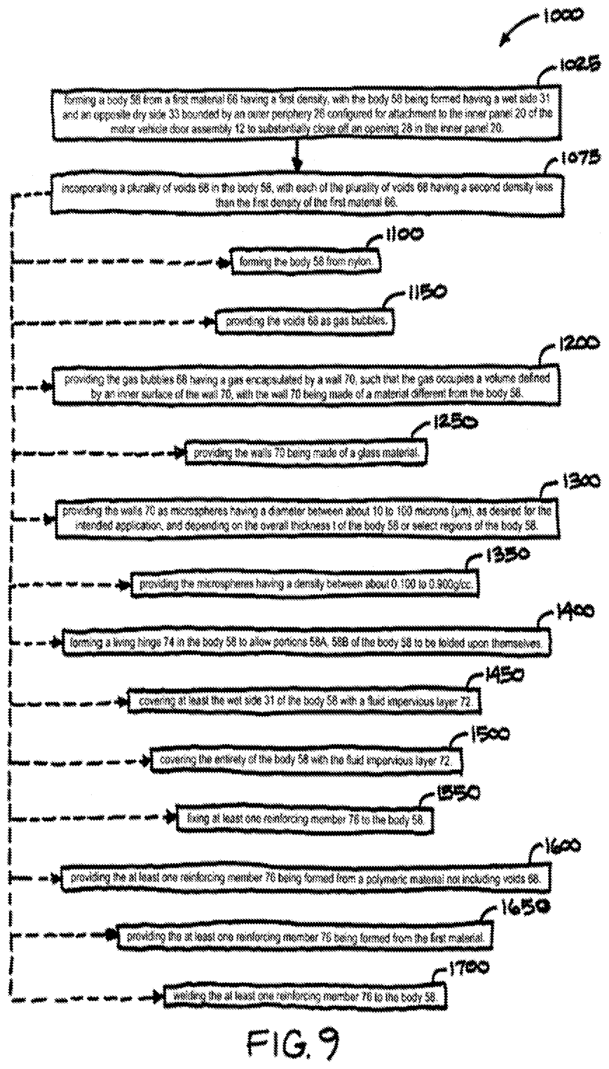

As shown in FIG. 9, a method 1000 of manufacturing a carrier 16 of a carrier module 10 for a motor vehicle door panel body 19 for at least partially or entirely closing off an opening 28 in an inner door panel, referred to hereafter as inner panel 20, of the motor vehicle door panel body 19 is provided to keep moisture and fluid from passing from a wet side (facing exterior environment E) of carrier module 10 to a dry side (facing an interior passenger cabin of motor vehicle 11) of carrier module 10. The method 1000 includes a step 1025 of forming a body 58 from a first material 66 having a first density, with the body 58 being formed having a wet side 31 and an opposite dry side 33 bounded by an outer periphery 26 configured for attachment to the inner panel 20 of the motor vehicle door assembly 12 to substantially close off an opening 28 in the inner panel 20. Further, a step 1075 of incorporating a plurality of voids 68 in the body 58, with each of the plurality of voids 68 having a second density less than the first density of the first material 66. Accordingly, the reduced density voids 68 function to reduce the overall density of the body 58 relative to that if the body 58 did not include the voids 68.

In accordance with another aspect of the disclosure, the method 1000 can further include a step 1100 of forming the body 58 from nylon. With nylon having a relative high strength, the thickness t of the body 58 can be minimized to optimize design of the door 12, while facilitating the reduction of weight of the door 12.

In accordance with another aspect of the disclosure, the method 1000 can further include a step 1150 of providing the voids 68 as gas bubbles.

In accordance with another aspect of the disclosure, the method 1000 can further include a step 1200 of providing the gas bubbles 68 having a gas encapsulated by a wall 70, such that the gas occupies a volume defined by an inner surface of the wall 70, with the wall 70 being made of a material different from the body 58.

In accordance with another aspect of the disclosure, the method 1000 can further include a step 1250 of providing the walls 70 being made of a glass material.

In accordance with another aspect of the disclosure, the method 1000 can further include a step 1300 of providing the walls 70 as microspheres having a diameter between about 10 to 100 microns (μm), as desired for the intended application, and depending on the overall thickness t of the body 58 or select regions of the body 58. Accordingly, it is to be understood that different diameter microspheres 70 can be used in different regions of the body 58, as desired to optimize the design desired.

In accordance with another aspect of the disclosure, the method 1000 can further include a step 1350 of providing the microspheres having a density between about 0.100 to 0.900 g/cc, as desired for the intended application. Accordingly, it is to be understood that different density microspheres 70 can be used in different regions of the body 58, as desired to optimize the design desired.

In accordance with another aspect of the disclosure, the method 1000 can further include a step 1400 of forming a living hinge 74 in the body 58 to allow portions 58A, 58B of the body 58 to be folded upon themselves.

In accordance with another aspect of the disclosure, the method 1000 can further include a step 1450 of covering at least the wet side 31 of the body 58 with a fluid impervious layer 72, thereby protecting the underlying material 66 of the body 58 against absorption of fluid/moisture.

In accordance with another aspect of the disclosure, the method 1000 can further include a step 1500 of covering the entirety of the body 58 with the fluid impervious layer 72.

In accordance with another aspect of the disclosure, the method 1000 can further include a step 1550 of fixing at least one reinforcing member 76 to the body 58.

In accordance with another aspect of the disclosure, the method 1000 can further include a step 1600 of providing the at least one reinforcing member 76 being formed from a polymeric material, with the at least one reinforcing member 76 not including the plurality of voids 68, and thus, being solid material throughout.

In accordance with another aspect of the disclosure, the method 1000 can further include a step 1650 of providing the at least one reinforcing member 76 being formed from the first material.

In accordance with another aspect of the disclosure, the method 1000 can further include a step 1700 welding the at least one reinforcing member 76 to the body 58, such as via ultrasonic welding, by way of example and without limitation, thereby bonding the materials of the body 58 and the reinforcing member 76 together. In a scenario where the body 58 and the at least one reinforcing member 76 are formed of similar materials, i.e. nylon, the bond joint between the body 58 and the at least one reinforcing member 76 is formed of the same material, thereby rendering the body 58 and the at least one reinforcing member 76 as a monolithic piece of the same material.

While the above description constitutes a plurality of embodiments of the present invention, it will be appreciated that the present invention is subject to further modification and change without departing from the fair interpretation and intended meaning of the accompanying claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A carrier for a carrier module of a motor vehicle door assembly having an inner panel and an outer panel defining a door panel structure with the inner panel having an opening to an internal door cavity between the inner panel and the outer panel, said carrier comprising:
a body with a wet side and an opposite dry side bounded by an outer periphery configured for attachment to the inner panel to at least partially close off the opening, said body being formed from a first material having a first density; and
a plurality of voids in said body, each of said plurality of voids having a second density less than said first density.

2. The carrier of claim 1, wherein said body is a polymeric material.

3. The carrier of any one of claim 2, wherein said voids are gas bubbles.

4. The carrier of claim 3, wherein each of said gas bubbles is encapsulated by a separate wall, said walls being formed of a material different from said body.

5. The carrier of claim 4, wherein said walls are glass.

6. The carrier of claim 4, wherein said walls are microspheres having a diameter between about 10 to 100 microns (μm).

7. The carrier of claim 6, wherein said microspheres have a density between about 0.100 to 0.900 g/cc.

8. The carrier of claim 1, wherein said body has a living hinge allowing portions of said body on opposite sides of said living hinge to be folded upon themselves.

9. The carrier of claim 1, further including a fluid impervious layer covering said wet side.

10. The carrier of claim 1, further including at least one reinforcing member fixed to said body, said at least one reinforcing member not including said plurality of voids.

11. A method of constructing a carrier for a carrier module of a motor vehicle door assembly, comprising:
forming a body from a first material having a first density, with the body being formed having a wet side and an opposite dry side bounded by an outer periphery configured for attachment to an inner panel of the motor vehicle door assembly to substantially close off an opening in the inner panel; and
incorporating a plurality of voids in the body, with each of the plurality of voids having a second density less than the first density of the first material.

12. The method of claim 11, further including forming the body from polyimide.

13. The method of claim 11, further including providing the voids as gas bubbles.

14. The method of claim 13, further including providing each of the gas bubbles having a gas encapsulated by a separate wall made of a material different from the body.

15. The method of claim 14, further including providing the walls being made of glass.

16. The method of claim 14, further including providing the walls as microspheres having a diameter between about 10 to 100 microns (μm).

17. The method of claim 11, further including forming a living hinge in the body to allow portions of the body to be folded upon themselves.

18. The method of claim 11, further including covering at least the wet side of the body with a fluid impervious layer.

19. The method of claim 11, further including fixing at least one reinforcing member to the body, with the at least one reinforcing member not including the plurality of voids.

20. The method of claim 19, further including welding the at least one reinforcing member to the body.
